(19) United States
(12) Patent Application Publication
(10) Pub. No.: US 2013/0129958 A1
(43) Pub. Date: May 23, 2013

(54) SCREEN PROTECTIVE FILM AND APPLICATIONS OF SAME

(71) Applicant: Jun Li, Duluth, GA (US)

(72) Inventor: Jun Li, Duluth, GA (US)

(21) Appl. No.: 13/679,332

(22) Filed: Nov. 16, 2012

Related U.S. Application Data
(60) Provisional application No. 61/561,587, filed on Nov. 18, 2011.
(60) Provisional application No. 61/700,259, filed on Sep. 12, 2012.

(51) Int. Cl. G02B 27/00

(52) U.S. Cl. CPC G02B 27/00
USPC 428/41.7; 428/43; 428/195.1

(57) ABSTRACT

A screen protective film usable for protecting a screen of an electronic device. The screen protective film includes a flexible layer, a plurality of protrusions and a spacer layer. The flexible layer has a first area corresponding to a touch area of the screen of the electronic device and a second area peripheral to the first area. The flexible layer is transparent and includes at least one opening on the second area. The protrusions are formed on the first area of the first surface of the flexible layer. The spacer layer is disposed on the second area of the first surface of the flexible layer.

### CROSS-REFERENCE TO RELATED APPLICATIONS

This non-provisional application claims priority to and the benefit of, pursuant to 35 U.S.C. §119(e), U.S. Provisional Patent Application No. 61/561,587, filed November 18, 2011, entitled “BUBBLE FREE REUSABLE SCREEN PROTECTOR AND METHOD OF MANUFACTURING SAME”, by Jun Li, and U.S. Provisional Patent Application No. 61/700,259, filed Sep. 12, 2012, entitled “SCREEN PROTECTION FILM AND APPLICATIONS OF SAME”, by Jun Li, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a screen protective film, and more particularly to a bubble free, reusable screen protective film and applications of the same.

### BACKGROUND OF THE INVENTION

Currently, a protective film is widely used for protecting an electronic device such as a smartphone, a tablet, a computer with a touch screen display, and other screen or display devices. The protective film includes a transparent layer, an adhesive layer formed on the a transparent layer and a disposable cover layer formed on the adhesive layer. When in use, the disposable cover layer is removed and the rest of the protective film is attached to a screen through the adhesive layer.

The traditional protective film may offer variety of functionalities. However, the protective film may be difficult to apply to the electronic device or may require professional installations. Further, after installing the protective film on the electronic device, visible air bubble may be formed between the protective film and the screen of the electronic device, especially when adhesive is used to statically adhere the protective film to the screen of the electronic device. Moreover, the protective film may be not removable, reusable.

Therefore, a heretofore unaddressed need exists in the art to address the aforementioned deficiencies and inadequacies.

### SUMMARY OF THE INVENTION

In one aspect, the present invention is directed to a screen protective film configured to be attached to a screen of an electronic device. In one embodiment, the screen protective film includes a flexible layer, a spacer layer and a plurality of protrusions. The flexible layer has a first surface and an opposite, second surface. The flexible layer comprises a first area corresponding to a touch area of the screen of an electronic device and a second area peripheral to the first area. The spacer layer is disposed on the second area of the first surface of the flexible layer. The plurality of protrusions is disposed on the first area of the first surface of the flexible layer.

In one embodiment, the first surface of the flexible layer is treated such that at least in the first area, the first surface of the flexible layer is a matted surface. In another embodiment, the screen protective film further has a matted thin layer formed between the first surface of the flexible layer and the protrusions.

In one embodiment, the second surface of the flexible layer is treated with different finishes including anti-fingerprint, anti-glare, anti-bacteria or high glossy.

In one embodiment, the plurality of protrusions is formed in a pattern.

In one embodiment, the plurality of protrusions is elastic.

In one embodiment, the spacer layer includes an adhesive layer disposed on the second area of the first surface of the flexible layer and a first disposable cover layer disposed on the adhesive layer. In a further embodiment, the spacer layer may further include an oil-ink layer disposed between the first surface of the flexible layer and the adhesive layer. In yet another embodiment, the first disposable cover layer has a first tearing tab.

In one embodiment, the adhesive layer comprises a plurality of adhesive patches. When the screen protective film is attached to the electronic device, at least one air passage is formed among the first surface of the flexible layer, the plurality of adhesive patches, and the electronic device.

In one embodiment, the screen protective film further includes a second disposable cover layer disposed on the second surface of the flexible layer.

In one embodiment, the second disposable cover layer has a second tearing tab.

In one embodiment, the flexible layer is transparent.

In one embodiment, the flexible layer has no opening formed on the second area. In another embodiment, the flexible layer has at least one opening on the second area.

In one embodiment, the flexible layer is made of flexible glass. In another embodiment, the flexible layer is made of polyethylene terephthalate (PET), polycarbonates (PC), polypropylene (PP), polyethylene naphthalate (PEN), polyimide (PI), cyclic olefin copolymer (COC), poly(methyl methacrylate) (PMMA), polyethersulphone (PES), copolyester thermoplastic elastomer (COP), polysulfone, phenolic resin, epoxy resin, polyester, polyetherester, polyetheramide, cellulose acetate, aliphatic polyurethane, polyacrylonitrile, polytetrafluoroethylenes, polyvinylidene fluorides, polytetrafluoroethylenes, or poly(methyl α-methacrylates).

In one embodiment, the flexible layer and the protrusions are integrally formed.

In another aspect, the present invention is directed to a screen protective film configured to be attached to an electronic device. In one embodiment, the screen protective film comprises a flexible layer having a first surface and an opposite, second surface, wherein the flexible layer comprises a first area corresponding to a touch area of the screen of the electronic device and a second area peripheral to the first area, and wherein the first surface of the flexible layer is matted at least in the first area; a plurality of protrusions formed on the first area of the first surface of the flexible layer; and a spacer layer disposed on the second area of the first surface of the flexible layer.

In one embodiment, the flexible layer and the protrusions are integrally formed.

In yet another aspect, the present invention is directed to a screen protective film configured to be attached to an electronic device. In one embodiment, the screen protective film comprises a flexible layer, a plurality of adhesive patches, and an oil-ink layer. The flexible layer has a first surface and an opposite, second surface. The flexible layer comprises a first area corresponding to a touch area of the screen of the electronic device and a second area peripheral to the first area. The adhesive patches are disposed on the second area of the second surface of the flexible layer. The oil-ink layer is disposed between the flexible layer and the adhesive patches. When the screen protective film is attached to the electronic device, at least one air passage is formed among the first surface of the flexible layer, the plurality of adhesive patches, and the electronic device.

In one embodiment, the adhesive patches are in circular, triangular, rectangular, square, hexagonal, or irregular shape.

In a further embodiment, the adhesive patches are arranged in a pattern.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1A shows schematically a top view of a screen protective film according to one embodiment of the present invention;

FIG. 1B shows schematically a cross-sectional view of the screen protective film along line A-A′ as shown in FIG. 1A;

FIG. 2 shows schematically a top view of a screen protective film attached to an electronic device according to one embodiment of the present invention, where the second disposable cover layer of the screen protective film is partially pealed off;

FIG. 3 shows schematically a bottom view of a screen protective film according to one embodiment of the present invention;

FIG. 4 shows schematically a enlarged partial view of the protrusions of the screen protective film according to one embodiment of the present invention;

FIG. 5 shows schematically a cross-sectional view of a screen protective film according to one embodiment of the present invention;

FIG. 6 shows schematically a cross-sectional view of a screen protective film attached to an electronic device according to one embodiment of the present invention;

FIG. 7 shows schematically a bottom view of a screen protective film according to another embodiment of the present invention; and

FIG. 8 shows schematically a bottom view of a screen protective film according to yet another embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention. As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

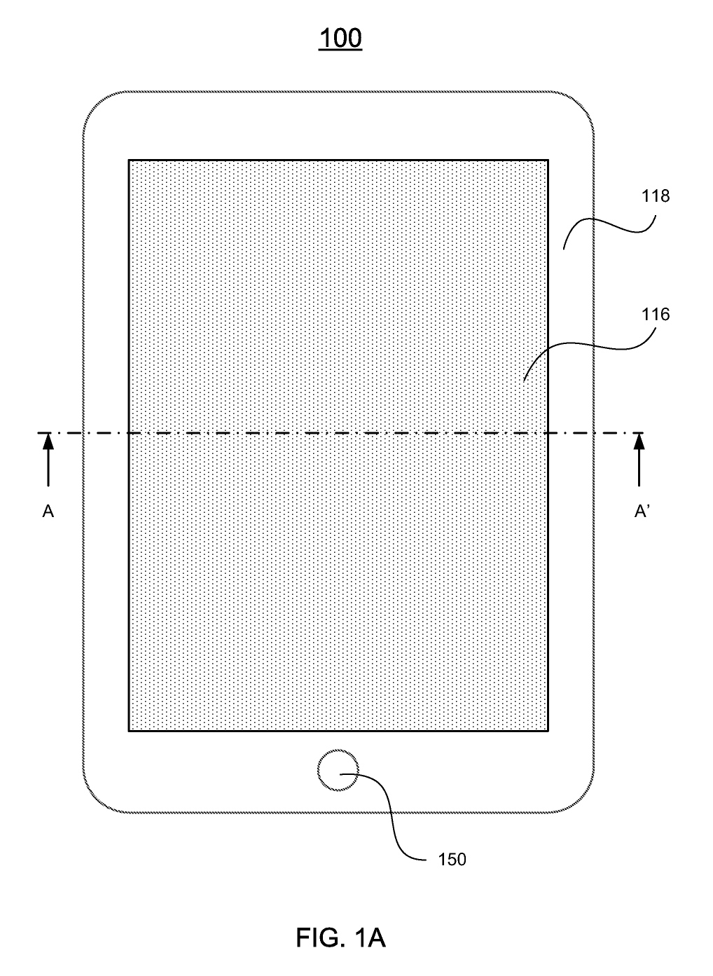

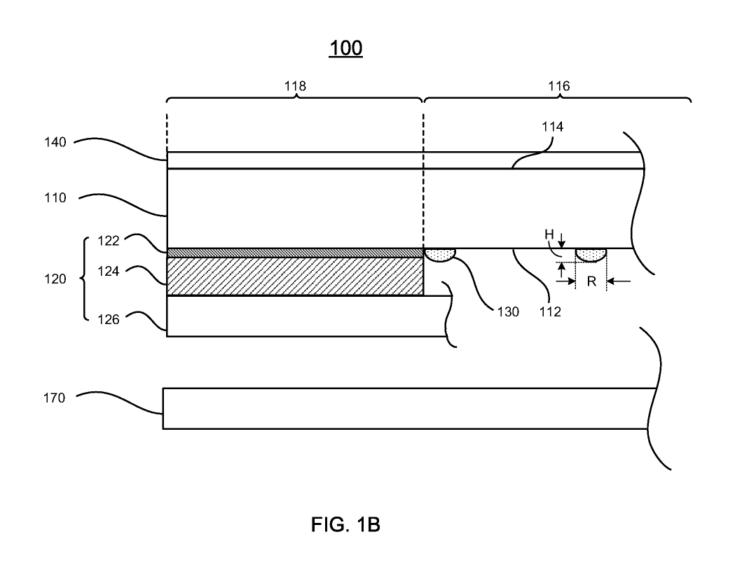

The description will be made as to the embodiments of the present invention in conjunction with the accompanying drawings in FIGS. 1-8. In accordance with the purposes of this invention, as embodied and broadly described herein, this invention, in one aspect, relates to a screen protective film and applications of the same.

FIGS. 1A and 1B show a screen protective film 100 according to one embodiment of the present invention, where FIG. 1A shows a top view of the screen protective film 100, and FIG. 1B shows a cross-sectional view of the screen protective film 100 along line A-A′ as shown in FIG. 1A. The screen protective film 100 is configured to be attached to a screen of an electronic device 170. The electronic device 170 may be a smartphone, a tablet, a computer with a touch screen display, or any other screen or display device, and the screen protective film 100 may have substantially the same size and shape as the electronic device 170.

As shown in FIGS. 1A and 1B, the screen protective film 100 includes a flexible layer 110, a spacer layer 120, and a plurality of protrusions 130. The flexible layer 110 serves as the protection layer for the electronic device 170, and has a first surface 112 and an opposite, second surface 114. When the flexible layer 110 is applied to the electronic device 170, the first surface 112 faces a surface of the electronic device 170 and is attached to the surface of the electronic device 170. The flexible layer 110 comprises a first area 116 and a second area 118. The first area 116 corresponds to a touch area or a responsive area of the electronic device 170. The second area 118 is peripheral to the first area 116, and corresponds to the edge area or non-responsive area surrounding the touch area or responsive area of the electronic device 170. In one embodiment, the flexible layer 110 may be transparent. In one embodiment, the flexible layer 110 is made of flexible glass. In another embodiment, the flexible layer 110 is made of plastics, such as polyethylene terephthalate (PET), polycarbonates (PC), polypropylene (PP), polyethylene naphthalate (PEN), polyimide (PI), cyclic olefin copolymer (COC), poly(methyl methacrylate) (PMMA), polyethersulphone (PES), copolyester thermoplastic elastomer (COP), polysulfone, phenolic resin, epoxy resin, polyester, polyetherester, polyetheramide, cellulose acetate, aliphatic polyurethane, polyacrylonitrile, polytetrafluoroethylenes, polyvinylidene fluorides, polytetrafluoroethylenes, or poly(methyl α-methacrylates). In one embodiment, the flexible layer is HC-PET (188 μm)-HC, with a light transmission rate of about 91.7%, a haze degree of about 0.75 and a pencil harness in a range of about 1-8 H. The thickness of the flexible layer 110 can be in a range of about 0.01-1.00 mm. In one embodiment, the thickness of the flexible layer 110 is about 0.188 mm. In another embodiment, the thickness of the flexible layer 110 is about 0.25 mm.

In one embodiment, the first surface 112 of the flexible layer 110 is treated such that at least in the first area 116, the first surface 112 of the flexible layer 110 is a matted surface. In another embodiment, the screen protective film further has a matted thin layer formed between the first surface 112 of the flexible layer 110 and the protrusions 130. Additionally, the second surface 114 of the flexible layer 110 can be treated with different finishes, such as anti-fingerprint, anti-glare, anti-bacteria or high glossy.

Optionally, the screen protective film 100 may have no opening formed on the second area 118 of the flexible layer 110, or may have at least one opening 150 formed on the second area 118 of the flexible layer 110. In the exemplary embodiment shown in FIGS.1-3, the screen protective film 100 further includes at least one opening 150 on the second area 118 of the flexible layer 110. The opening 150 is provided at the position corresponding to a feature element of the electronic device 170, such as a button, a “Home” key, a camera lens, a speaker, a microphone, etc. so that the function of the feature element of the electronic device 170 may not be blocked or affected. In one embodiment, the opening 150 is a through hole such that, after the screen protective film 100 is applied to the electronic device 170, the feature element of the electronic device 170 is exposed to allow functions of the feature element without being affected by the screen protective film 100. As shown in FIG. 1A, there is one opening 150. Alternatively, the number of openings 150 may be two or more.

As shown in the top view of FIG. 1A, a portion of the screen protective film 100 corresponding to the first area 116 is transparent, and another portion of the screen protective film 100 corresponding to the second area 118 may be non-transparent or transparent.

The spacer layer 120 is disposed on the second area 118 of the first surface 112 of the flexible layer 110. As shown in FIG. 1B, the spacer layer 120 includes an oil-ink layer 122, an adhesive layer 124, and a first disposable cover layer 126. The first disposable cover layer covers the entire back side of the screen protective film 100, i.e., the same area as the second disposable layer 140. The oil-ink layer 122 is disposed on the second area 118 of the first surface 112 of the flexible layer 110. Specifically, the oil-ink layer 122 can be printed or sputtered on the second area 118 of the first surface 112 of the flexible layer 110. Accordingly, when seen from the top of the screen protective film 100, the portion corresponding to the second area 118 of the flexible layer 110 may be opaque or transparent, with desired printed patterns of the oil-ink layer 122. The print color of the oil-ink layer 122 can be any colors, such as black, white, silver, or a combination thereof.

The adhesive layer 124 is disposed on the oil-ink layer 122. In certain embodiments, if the oil-ink layer 122 is not presented, the adhesive layer 124 may also be disposed directly on the second area 118 of the first surface 112 of the flexible layer 110. In one embodiment, the adhesive layer 124 is a double-sided adhesive layer. In one embodiment, the adhesive material of the adhesive layer 124 has low viscosity. In addition, the adhesive layer 124 may a plurality of adhesive patches (not shown), such that when the screen protective film 100 is attached to the screen of electronic device, at least one air passage is formed among the first surface 112 of the flexible layer 110, the plurality of adhesive patches, and the electronic device.

The first disposable cover layer 126 is disposed on the adhesive layer 124. When in use, the first disposable cover layer 126 can be removed easily to expose the adhesive layer 124 for attaching to the electronic device 170.

The protrusions 130 are disposed on the first area 116 of the first surface 112 of the flexible layer 110. In one embodiment, the protrusions 130 are elastic. In certain embodiments, the material of the protrusions 130 may be the same as or different from the material of the flexible layer 110. The protrusions 130 may be formed on or grown from the flexible layer 110. In one embodiment, the protrusions 130 may be integrally formed with the flexible layer 110. Alternatively, the protrusions 130 may be formed on the flexible layer 110 after the flexible layer 110 is provided. In one embodiment, after the screen protective film 100 is applied to the electronic device 170, the protrusions 130 are in contact with the touch area of the screen of the electronic device 170. In other embodiments, after the screen protective film 100 is applied to the electronic device 170, the protrusions 130 may partially, or may not be in contact with the touch area of the screen of the electronic device 170. The protrusions 130 may be in a variety of shapes and sizes. In one embodiment, as shown in FIG. 1B, the protrusions 130 are round dots having a diameter, R, in a range of 0.001-0.05 mm and a height, H, in a range of 0.008-0.12 mm. In one embodiment, the diameter R of the protrusions 130 is about 0.03 mm. The height H is not higher than the thickness of the spacer layer 120.

As shown in FIG. 1B, the screen protective film 100 may further include a second disposable cover layer 140 disposed on the second surface 114 of the flexible layer 110 for protecting the screen protective film 100.

The thickness of the first detachable layer 126 is in a range of about 0.03-0.5 mm. In one embodiment, the thickness of the first detachable layer 126 is about 0.12 mm.

The thickness of the adhesive layer 124 is in a range of about 0.02-0.5 mm. In one embodiment, the thickness of the adhesive layer 124 is about 0.08 mm. In another embodiment, the thickness of the adhesive layer 124 is about 0.3 mm.

The thickness of the oil-ink layer 122 is in a range of about 0.005-0.1 mm. In one embodiment, the thickness of the oil-ink layer 122 is about 0.022 mm.

The thickness of the plurality of protrusions 130 is in a range of about 0.001-0.12 mm. In one embodiment, the thickness of the plurality of protrusions 130 is about 0.03 mm.

The thickness of the flexible layer 110 is in a range of about 0.01-1.00 mm. In one embodiment, the thickness of the flexible layer 110 is about 0.188 mm. In another embodiment, the thickness of the flexible layer 110 is about 0.25 mm.

The thickness of the second detachable layer 140 is in a range of about 0.01-0.15 mm. In one embodiment, the thickness of the second detachable layer 140 about 0.04 mm.

The total thickness of the screen protective film 100 is in a range of about 0.1-2 mm. In one embodiment, the thickness of the screen protective film 100 is about 0.5 mm.

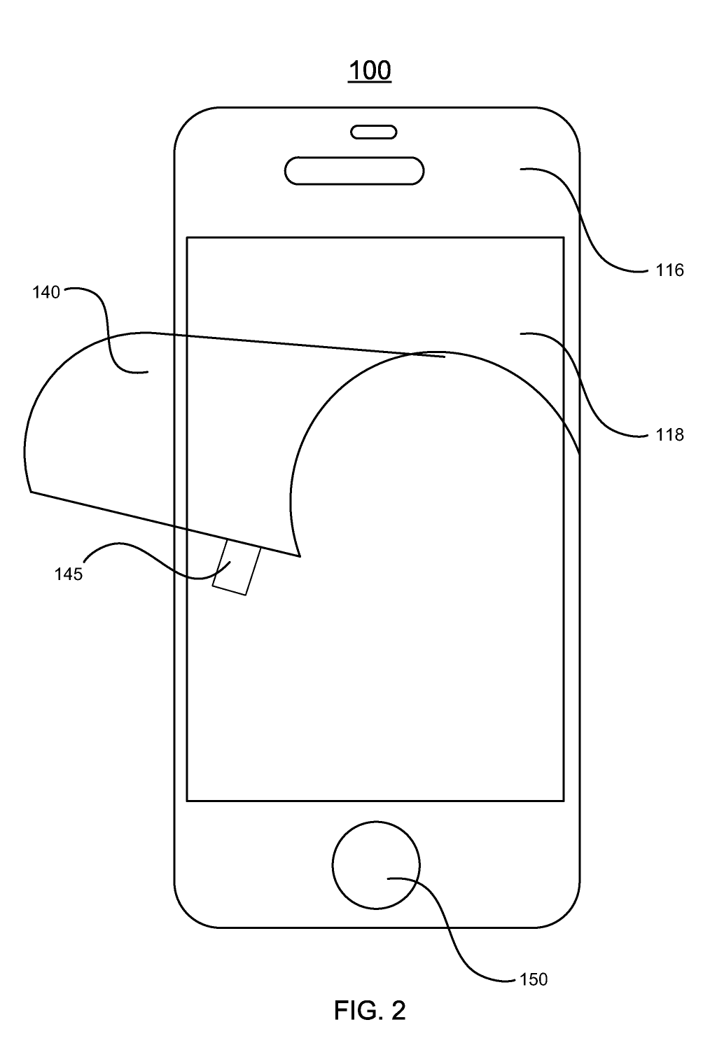

FIG. 2 shows schematically a top view of the screen protective film 100 attached to the electronic device according to one embodiment of the present invention, where the second disposable cover layer 140 of the screen protective film 100 is partially pealed off. As shown in FIG. 2, the screen protective film 100 is attached to the electronic device, and the second disposable cover layer 140 further includes a second tearing tab 145 for pealing off the second disposable cover layer 140. When in use, the second disposable cover layer 140 can be removed easily by applying a pulling force to the second tearing tab 145 to peal off the second disposable cover layer 140. As shown in FIG. 2, the second disposable cover 140 is partially pealed off from the screen protective film 100 by pulling the second tearing tab 145. The second disposable cover layer 140 may cover the entire flexible layer 110, or may cover only a portion of the flexible layer 110.

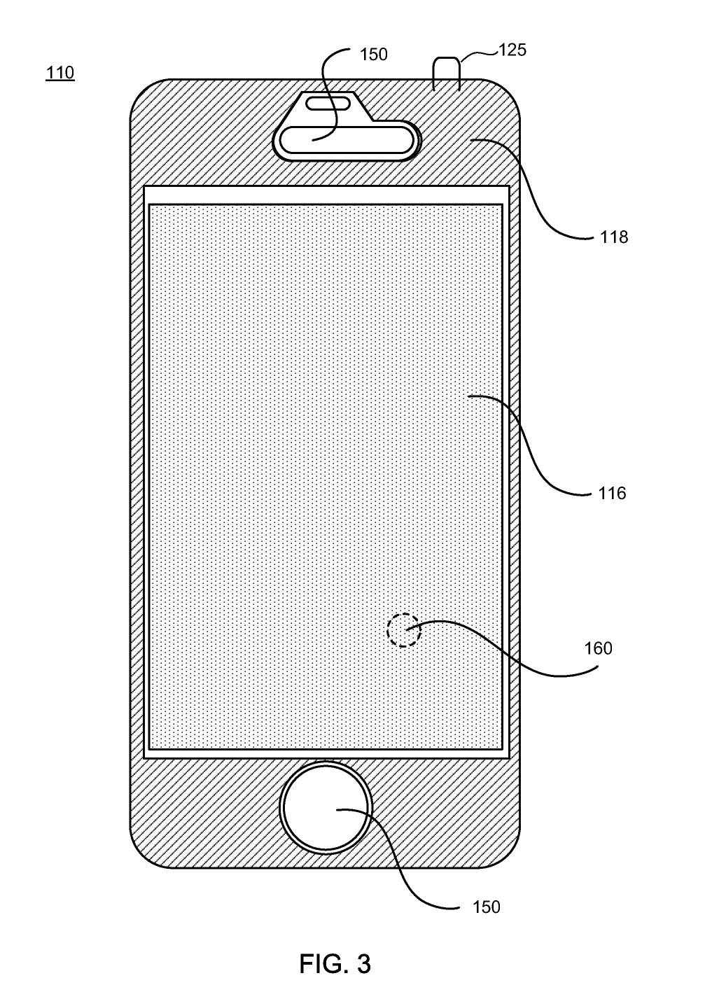

FIG. 3 shows a bottom view of the screen protective film 100. The first area 116 of the first surface 112 of the flexible layer 110 corresponds to a touch area or a responsive area or a display area of the electronic device 170. The protrusions 130 are formed on the first area 116 of the first surface 112 of the flexible layer 110. The protrusions 130 may occupy all the first area 116, or may cover a portion of the first area 116 and leave a small space between the first area 116 and the second area 118.

As shown in FIG. 3, the first disposable cover layer 126 has a first tearing tab 125. When in use, the first disposable cover layer 126 can be removed easily by applying a pulling force to the first tearing tab 125 to peal off the first disposable cover layer 126. The spacer layer 120 is disposed on the second area 118 of the first surface 112 of the flexible layer 110, surrounding the first area. During installation, after pulling the first tearing tab 125 of the first disposable layer 126, the adhesive layer 124 is exposed. Then, the exposed adhesive layer 124 may be pressed to the surface of the electronic device 170 such that the screen protective film 100 is attached to the electronic device 170. The adhesive layer 124 corresponds to the area peripheral to the touch area of the electronic device 170, and thus will not leave scum or residues on the touch screen.

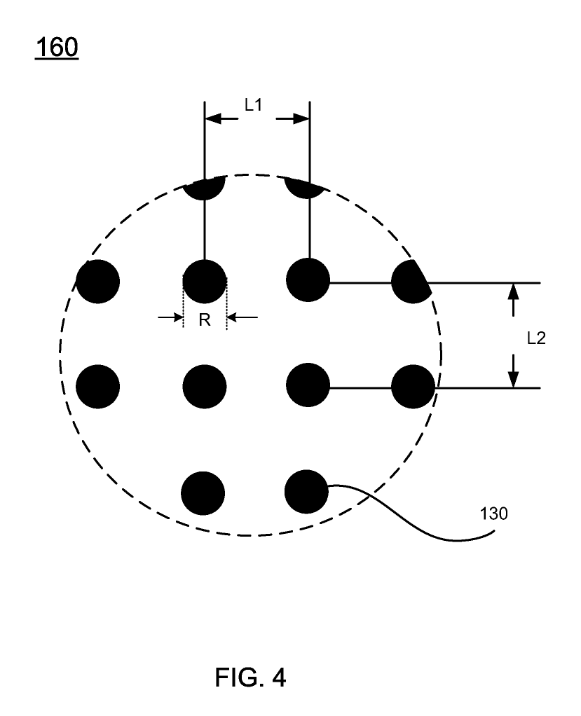

FIG. 4 shows an enlarged view of the plurality of protrusions 130 in area 160 as shown in FIG. 3. The protrusions 130 may be in a variety of shapes and sizes. In one embodiment, as shown in FIG. 1B, the protrusions 130 are round dots having a diameter R in the range of 0.001-0.12 mm and the height H in a range of 0.001-0.5 mm. The protrusions 130 may form a regular or irregular pattern. For example, as shown in FIG. 4, the protrusions 130 are formed in parallel rows and lines. In certain embodiments, the protrusions 130 may be arranged in other patterns, such as staggered patterns. As shown in FIG. 4, a distance L1 between two neighboring lines of protrusions 130 and a distance L2 between two neighboring rows of protrusions 130 may be equal or unequal. The length of the distances L1 and L2 may in a range of about 0.1 mm to 2 mm. In one embodiment, the distances of L1 and L2 are about 1 mm.

When in use, a user may peal off the first disposable layer 126 from the screen protective film 100 by applying a pulling force to the first tearing tab 125 as shown in FIG. 3. Thus, the first area 116 of the first surface 112 of the flexible layer 110, the adhesive layer 124, and the protrusions 130 are exposed. Then, the above exposed side of the screen protective film 100 is placed to face a screen of the electronic device 170. By lightly pressing the second area 118, the screen protective film 100 is attached to the screen of the electronic device 170. The second disposable layer 140 may be also pealed off by pulling the second tearing tab 145 as shown in FIG. 2.

The screen protective film of the invention has, among other things, many advantages over the conventional protecting films:
Bubble free: because the protective film has no direct contact with the screen, and therefore will not produce any bubbles between the protective film and the screen. Alternatively, the air between the screen and the flexible layer 110 is invisible.
Waterline/watermarks free: because the transparent area 116 of the protective film has the plurality of dots (protrusions) 130 regularly or irregularly formed on or grown from the transparent area 116, it is not in contact with the screen, even if touch force(s) are applied to the protective film, therefore no waterlines or watermarks are generated.
Rainbow effect free or the rainbow effect is significantly minimized, because of the matted surface in the first area of the flexible layer.
Easy to install: because of the use of double-sided adhesive protective film with a low viscosity around edge portions, it is easy to peel off and does not leave a scum/residues, meanwhile, no scum/residues exists on the edge viscose portions.
High transparency: the use of the dot/protrusion technology ensures the screen to be highly transparent, and protected from environmental pollutions. When protected with the screen protective film, the touch sensitivity and operability of the screen are not compromised. Further, the screen protective film is scratching resistant.

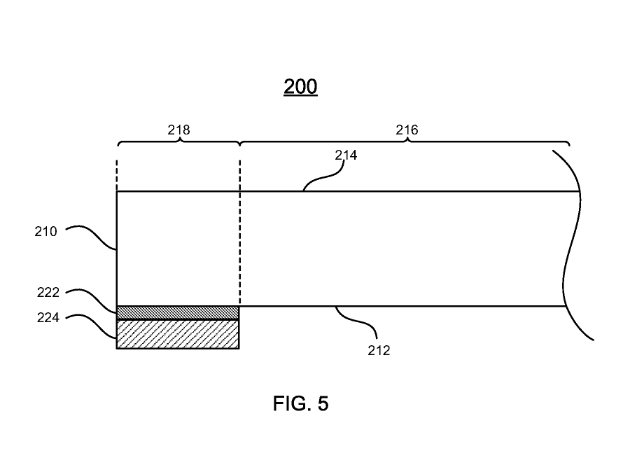

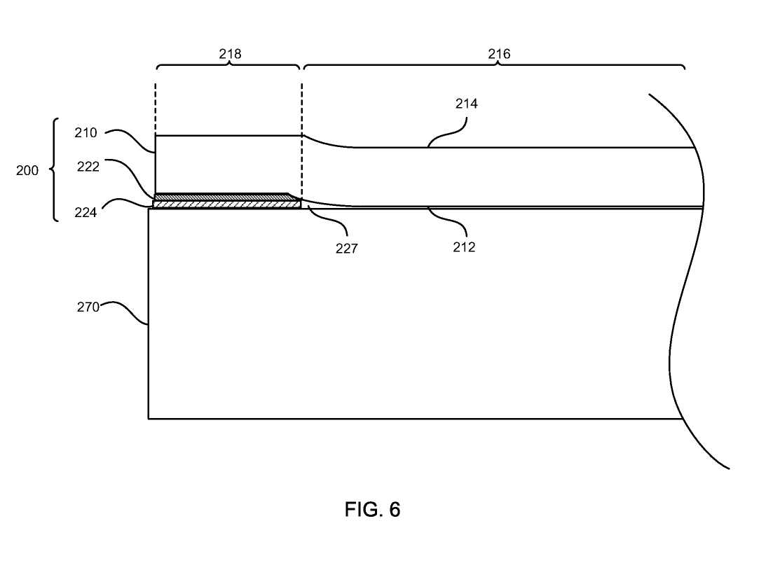

FIGS. 5 and 6 show a screen protective film 200 according to another embodiment of the present invention. The screen protective film 200 is configured to be attached to an electronic device 270. As shown in FIG. 5, the screen protective film 200 includes a flexible layer 210, a plurality of adhesive patches 224, and an oil-ink layer 222. The flexible layer 210 has a first surface 212 and an opposite, second surface 214. When the flexible layer 210 is applied to the electronic device 270, as shown in FIG. 6, the first surface 212 faces a surface of the electronic device 270 and is attached to the surface of the electronic device 270. The flexible layer 210 includes a first area 216 and a second area 218. The first area 216 corresponds to a touch area of the electronic device and the second area 218 is peripheral to the first area 216.

The adhesive patches 224 are disposed on the second area 218 of the second surface 212 of the flexible layer 210. The oil-ink layer 222 is disposed between the flexible layer 220 and the adhesive patches 224. The print color of the oil-ink layer 222 may be adjusted to match the original color of the electronic device 270, especially the surface or the touch area of the electronic device, such that after applied to the electronic device, the screen protective film 200 appears invisible to a user and hides the complex structure from the user. Alternatively, if the oil-ink layer 222 is not presented, the adhesive patches 224 may also be disposed directly on the second area 218 of the first surface 212 of the flexible layer 210. In one embodiment, the adhesive patches 224 are double-sided adhesive patches.

In certain embodiments, the thickness of the oil-inked layer 222 and the adhesive patches 224 may be much less than the thickness of the flexible film 210. As shown in FIG. 6, when the screen protective film 200 is attached to the surface of the electronic device 270, the oil-ink layer 222 and the adhesive patches 224 are so thin that the first area 216 of the first surface 212 of the flexible layer is in contact with the screen of the electronic device 270. Only an air housing 227 is formed between the flexible layer 210 and the surface of the electronic device 270 at the interface of the first area 216 and the second area 218 of the flexible layer 210.

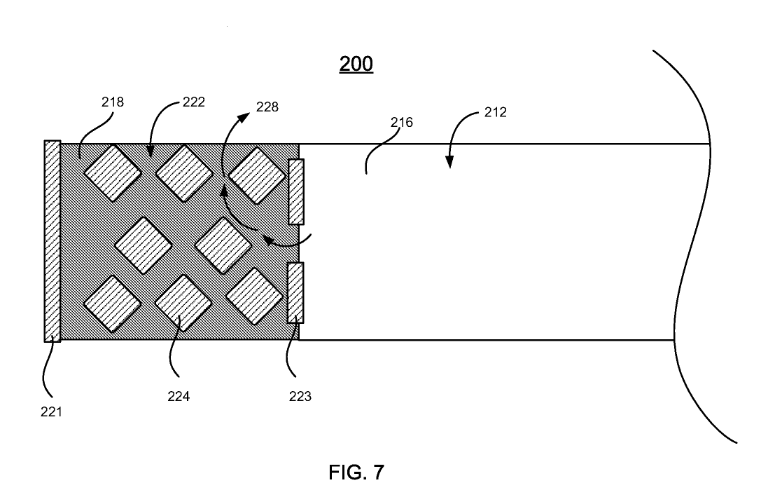

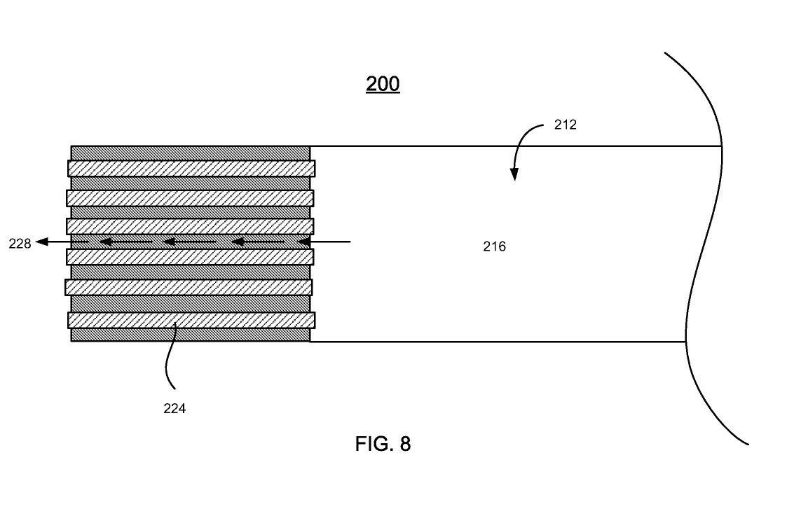

FIGS. 7 and 8 respectively show two embodiments of screen protective films with different adhesive patches 224. In certain embodiments, each adhesive patch 224 may in circular, triangular, rectangular, square, hexagonal, or irregular shapes, and the adhesive patches 224 may be arranged in a regular or irregular pattern. As shown in FIG. 7, the adhesive patches may include a seal 221, two enforcement patches 223, and other square-shaped adhesive patches 224. The seal 221 is provided to seal the outer area of the screen protective film 200 so as to block any small objects from entering the space between the adhesive patches 224 and the touch area of the electronic device. The enforcement patches 223 are located at the interface of the first area 216 and the second area 218 to provide extra support and adhesion to the electronic device, which may be adjusted according to the size of the electronic device and the size of the touch area of the electronic device, while still allow the air flow from the first area 216 through the second area 218. The adhesive patches 221, 223 and 224 are machine printed directly to the second area 218 of first surface 212 of the flexible layer 210, in order to achieve the best precision and consistency. Further, the number, shape and arrangement of the adhesive patches 221, 223 and 224 may be adjusted according to the material used. For example, FIG. 8 shows another embodiment, where the adhesive patches 224 are parallel stripes.

As shown in FIGS. 7 and 8, when the screen protective film 200 is attached to the electronic device 270, at least one air passage 228 is formed among the first surface 212 of the flexible layer 210, the plurality of adhesive patches 224, and the electronic device 270.

It should be appreciated that the embodiments as shown in FIGS. 1-4 and the embodiments as shown in FIGS. 5-8 may be combined together. For example, in one embodiment, the flexible layer 210 as shown in FIG. 5 may be provided with a plurality of protrusions, which has the similar structures to the protrusions 130 as shown in FIG. 1B. In a further embodiment, the adhesive layer 124 as shown in FIG. 1A may include a plurality of adhesive patches, which has the similar structures to the adhesive patches 224 as shown in FIG. 7 or FIG. 8.

According to the invention, improved usability with more than 90% of the film is naturally in contact with the responsive area, only a small portion of the area at the border is not in contact with the electronic device, which provides superior usability for the responsive area, at the same time it does not reduce the usability of the touchscreen at the edge because touchscreen device normally don't have touchable action at the edge of screen due to the size of the human finger.

It should be appreciated that the screen protective film of the present invention, when designed with different type of PET, PC, PP, flexible glass and other films or combination thereof, may have the function of clear transparent protection, anti-glare or anti-reflections, anti-bacteria, reduced fingerprint mark, and privacy protection. Further, the screen protective film of the present invention may be removable, reusable and washable.

In sum, the screen protective film of the present invention allows bubble free installation. There is no adhesive between the screen protective film and the touch area of the electronic device, and the screen protective film is not statically adhered to the touch area. Because the screen protective film has no direct contact with the touch area, no bubble is generated between the screen protective film and the touch area when applying the screen protective film to the electronic device.

The screen protective film of the present invention is waterline or watermarks free. Because the first transparent area has the protrusions regularly formed on or grown from the first area of the first surface of the flexible layer, the flexible layer is not in direct contact with the screen, even if touch forces are applied to the screen protective film. Accordingly, no waterlines or watermarks are generated. Further, the screen protective film is rainbow effect free or the rainbow effect is significantly minimized, because of the matted surface in the first area of the flexible layer.

The screen protective film of the present invention is easy to install. Because of the use of double sided adhesive screen protective film with a low viscosity around the second area, i.e., the edge portions surrounding the touch screen, it is easy to peel off and does not leave a scum or residues. Meanwhile, no scum or residues exists on the edge viscous portions. For an inexperienced user, it may take only tens of seconds to install and reinstall the screen protective film.

The screen protective film of the present invention has high transparency. The use of the protrusion technology ensures the screen to be highly transparent, and protect from environment pollutions. When protected with the screen protective film, the touch sensitivity and operability of the screen are not compromised. Further, the screen protective film is scratching resistant.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A screen protective film usable for protecting a screen of an electronic device, comprising:
a flexible layer having a first surface and an opposite, second surface, wherein the flexible layer comprises a first area corresponding to a touch area of the screen of the electronic device and a second area peripheral to the first area;
a plurality of protrusions formed on the first area of the first surface of the flexible layer; and
a spacer layer disposed on the second area of the first surface of the flexible layer,
wherein each protrusion has a height that is not higher than a thickness of the spacer layer.

2. The screen protective film according to claim 1, wherein the plurality of protrusions is formed in a pattern.

3. The screen protective film according to claim 1, wherein the plurality of protrusions is elastic.

4. The screen protective film according to claim 1, wherein the spacer layer comprises:
an adhesive layer disposed on the second area of the first surface of the flexible layer; and
a first disposable cover layer disposed on the adhesive layer.

5. The screen protective film according to claim 4, wherein the spacer layer further comprises an oil-ink layer disposed between the first surface of the flexible layer and the adhesive layer.

6. The screen protective film according to claim 4, wherein the first disposable cover layer comprises a first tearing tab.

7. The screen protective film according to claim 4, wherein the adhesive layer comprises a plurality of adhesive patches, such that when the screen protective film is attached to the screen of electronic device, at least one air passage is formed among the first surface of the flexible layer, the plurality of adhesive patches, and the electronic device.

8. The screen protective film according to claim 1, further comprising a second disposable cover layer disposed on the second surface of the flexible layer.

9. The screen protective film according to claim 8, wherein the second disposable cover layer comprises a second tearing tab.

10. The screen protective film according to claim 1, wherein the flexible layer is transparent.

11. The screen protective film according to claim 1, wherein the flexible layer has no opening formed on the second area, or has at least one opening formed on the second area.

12. The screen protective film according to claim 1, wherein the flexible layer is made of flexible glass, or one of polyethylene terephthalate (PET), polycarbonates (PC), polypropylene (PP), polyethylene naphthalate (PEN), polyimide (PI), cyclic olefin copolymer (COC), poly(methyl methacrylate) (PMMA), polyethersulphone (PES), copolyester thermoplastic elastomer (COP), polysulfone, phenolic resin, epoxy resin, polyester, polyetherester, polyetheramide, cellulose acetate, aliphatic polyurethane, polyacrylonitrile, polytetrafluoroethylenes, polyvinylidene fluorides, polytetrafluoroethylenes, and poly(methyl α-methacrylates).

13. The screen protective film according to claim 1, wherein the flexible layer and the protrusions are integrally formed.

14. The screen protective film according to claim 1, wherein the first surface of the flexible layer is treated such that at least in the first area, the first surface of the flexible layer is a matted surface.

15. The screen protective film according to claim 1, wherein the second surface of the flexible layer is treated with different finishes including anti-fingerprint, anti-glare, anti-bacteria or high glossy.

16. The screen protective film according to claim 1, further comprising a matted thin layer formed between the first surface of the flexible layer and the protrusions.

17. A screen protective film usable for protecting a screen of an electronic device, comprising:
a flexible layer having a first surface and an opposite, second surface, wherein the flexible layer comprises a first area corresponding to a touch area of the screen of the electronic device and a second area peripheral to the first area, and wherein the first surface of the flexible layer is treated such that the first surface of the flexible layer is a matted surface at least in the first area;
a plurality of protrusions formed on the first area of the first surface of the flexible layer; and
a spacer layer disposed on the second area of the first surface of the flexible layer,
wherein each protrusion has a height that is not higher than a thickness of the spacer layer.

18. The screen protective film according to claim 17, wherein the flexible layer is made of flexible glass, or one of polyethylene terephthalate (PET), polycarbonates (PC), polypropylene (PP), polyethylene naphthalate (PEN), polyimide (PI), cyclic olefin copolymer (COC), poly(methyl methacrylate) (PMMA), polyethersulphone (PES), copolyester thermoplastic elastomer (COP), polysulfone, phenolic resin, epoxy resin, polyester, polyetherester, polyetheramide, cellulose acetate, aliphatic polyurethane, polyacrylonitrile, polytetrafluoroethylenes, polyvinylidene fluorides, polytetrafluoroethylenes, and poly(methyl a-methacrylates).

19. The screen protective film according to claim 17, wherein the flexible layer and the protrusions are integrally formed.

20. A screen protective film usable for protecting a screen of an electronic device, comprising:
a flexible layer having a first surface and an opposite, second surface, wherein the flexible layer comprises a first area corresponding to a touch area of the screen of the electronic device and a second area peripheral to the first area;
a plurality of adhesive patches disposed on the second area of the second surface of the flexible layer; and
an oil-ink layer disposed between the flexible layer and the plurality of adhesive patches,
wherein when the screen protective film is attached to the screen of the electronic device, at least one air passage is formed among the first surface of the flexible layer, the plurality of adhesive patches, and the screen of the electronic device.
